(19) United States
(12) Patent Application Publication
(10) Pub. No.: US 2006/0240241 A1
(43) Pub. Date: Oct. 26, 2006

(54) Selectively reinforced carbon foam bodies

(75) Inventors: Susan C. Chang, Canonsburg, PA (US); Brian E. Joseph, Wheeling, WV (US); Rick Lucas, St.Clairsville, OH (US)

Correspondence Address: PHILIP D. LANE, P.O. BOX 79318, CHARLOTTE, NC, 28271-7063, US

(73) Assignee: Touchstone Research Laboratory, Ltd.

(21) Appl. No.: 11/331,416

(22) Filed: Jan. 12, 2006

Related U.S. Application Data
(60) Provisional application No. 60/643,155, filed on Jan. 12, 2005.

(51) Int. Cl. B32B 18/00; B32B 3/26

(52) U.S. Cl. 428/304.4; 428/293.4

(57) ABSTRACT

A selectively reinforced carbon foam body is described. The carbon foam body includes one or more reinforcement regions in predetermined locations within the carbon foam body. The reinforcement regions may be formed by permeating portions of the carbon foam body with a precursor to a reinforcement material in a predetermined pattern to form one or more reinforcement regions. The reinforcement regions may have differing sizes and shapes. The selective reinforcement of a carbon foam body allows for additional strength to be provided in needed areas while still maintaining the low density attributes of carbon foam.

### CROSS-REFERENCE TO RELATED APPLICATIONS

This application claims priority to U.S. Provisional Patent Application No. 60/643,155, filed Jan. 12, 2005, which is herein specifically incorporated by reference in its entirety.

### SUMMARY OF THE INVENTION

Embodiments of the invention are directed to the selective reinforcement of a carbon foam body. The selective reinforcement may be accomplished by infiltrating a portion of the carbon foam body with a reinforcement material to provide a reinforcement region of the carbon foam body.

Embodiments of the invention may include a reinforced carbon foam body. The reinforced carbon foam body may include a carbon foam body comprising carbon foam and having an exterior surface, wherein pores of the carbon foam comprising the carbon foam body have an average pore diameter. The carbon foam body has at least one reinforcement region within the exterior surface of the carbon foam body and extending from the exterior surface into the carbon foam body a distance of at least four times the average pore diameter. An unreinforced region may be included within the carbon foam body.

The reinforced carbon foam body may further include at least two reinforcement regions within the carbon foam body. Each reinforcement region may include a reinforcement material infiltrated into a portion of the carbon foam body. Optionally, the reinforcement material may extend through the carbon foam body from one surface of the carbon foam body to another surface of the same carbon foam body. Still further, the reinforced carbon foam body may include at least two reinforcement regions having shapes different from one another.

Still further, the invention may include a reinforced carbon foam body comprising a carbon foam body having an exterior surface, wherein the carbon foam comprising the carbon foam body has an average pore diameter. The carbon foam body has at least one reinforcement region substantially including the exterior surface of the carbon foam body and extending from the exterior surface into the carbon foam body a distance of at least four times the average pore diameter. In some embodiments the distance may range from about four times to about ten times the average pore diameter. The reinforced carbon foam body may also include an unreinforced region within the carbon foam body.

The reinforcement material may include a polymeric material such as polyurethane, semi-rigid polyurethane, polyethylene, polypropylene, polyester, silicone-based polymers, nylon, latex, rubber, acrylics, polycarbonates, resorcinol resins, furfural resins, isocyanates, epoxies, phenolics, or cyanate esters. Reinforcement materials may also include pitches, tars, mesophase materials, and the like, either carbonized or uncarbonized. In some embodiments, the carbon foam of the carbon foam body may have a density ranging from about 0.05 g/cc to about 1.0 g/cc and a compressive strength ranging from about 150 p.s.i. to about 10,000 p.s.i, or greater. In other embodiments, the carbon foam of the carbon foam body may have a compressive strength ranging from about 2,000 p.s.i. to about 6,000 p.s.i. The carbon foam of the carbon foam body may be a green carbon foam, a carbonized carbon foam, or a graphitized carbon foam.

### BRIEF DESCRIPTION OF THE DRAWINGS

FIG. 1 is a perspective representation of a selectively reinforced carbon foam body in accordance with an embodiment of the invention.

FIG. 2 is a cross-sectional representation of the embodiment shown in FIG. 1.

FIG. 3 is a perspective representation of a selectively reinforced carbon foam body in accordance with another embodiment of the invention.

FIG. 4 is a cross-sectional representation of the embodiment shown in FIG. 3.

FIG. 5 is a cross-sectional representation of yet another embodiment of the invention.

### DETAILED DESCRIPTION

Carbon foam is a strong, yet lightweight, porous carbon material that may be used in a variety of applications. For example, carbon foam may be used for a variety of structural applications. Carbon foam may be fastened to other pieces of carbon foam or to other materials as part of the structure or may be positioned to withstand an applied static or dynamic load. Because mechanical fastening techniques are difficult to implement when fastening carbon foam to other carbon foam pieces or other materials, carbon foams are often fastened through the use of a glue or adhesive. The glue or adhesive is typically applied to the external surface of the carbon foam to be bonded to another carbon foam piece or material. The glue or adhesive generally fills the outermost exterior pores of the carbon foam and generally only penetrates to a depth of one or two pore diameters into the carbon foam.

By selectively reinforcing carbon foam, the reinforcement regions may provide regions that would allow for a variety of mechanical fastening techniques. Further, reinforced regions of the carbon foam may provide for regions that can bear additional or higher loads. It is desirable to provide reinforced regions of the carbon foam to selectively enhance the strength of the carbon foam without significantly losing the lightweight and high strength advantages typically associated with the carbon foam.

In certain embodiments, predetermined regions of a carbon foam body may be selectively reinforced by infiltration with a reinforcement material. The selectively reinforced regions provide additional strength in infiltrated regions of the carbon foam body without having to infiltrate the entire carbon foam body. In this way additional strength may be selectively provided in predetermined areas without unnecessarily increasing the weight of the carbon foam body that would result from infiltrating the entire carbon foam body.

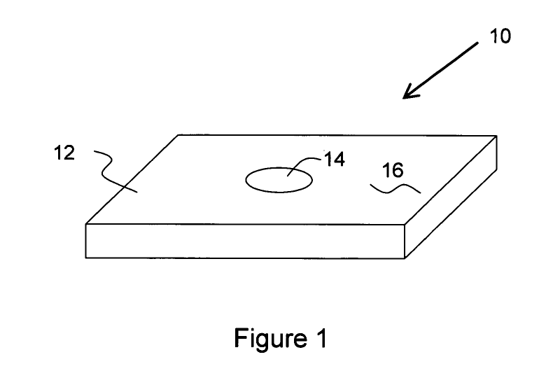

With reference now to FIG. 1, there is shown a selectively reinforced carbon foam body 10 in accordance with an embodiment of the invention. The selectively reinforced carbon foam body 10 includes a carbon foam body 12 having a reinforcement region 14 and an unreinforced region 16. The reinforcement region 14 is a portion of the carbon foam body that has been reinforced with a reinforcement material. The unreinforced region 16 is the remaining area of the carbon foam body 12 that has not been reinforced and remains largely carbon foam.

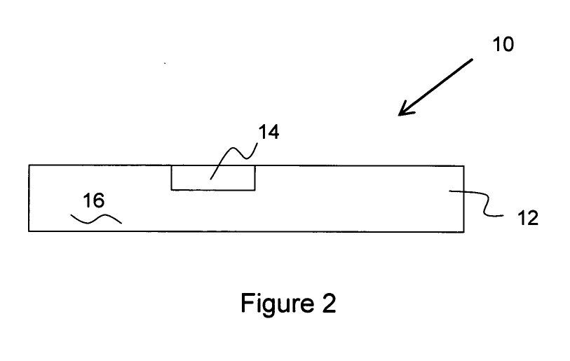

While the embodiment shown in FIG. 1 illustrates a largely circular reinforcement region, the reinforcement region may form any number of desired regular or irregular geometric patterns on the surface of the carbon foam body. The reinforcement region 14 extends from the surface of the carbon foam body into the interior of the carbon foam body 12 at least four times the average pore diameter of the pores of the carbon foam comprising the carbon foam body. As shown in FIG. 2, the reinforcement region 14 may extend partially into the interior of the carbon foam body.

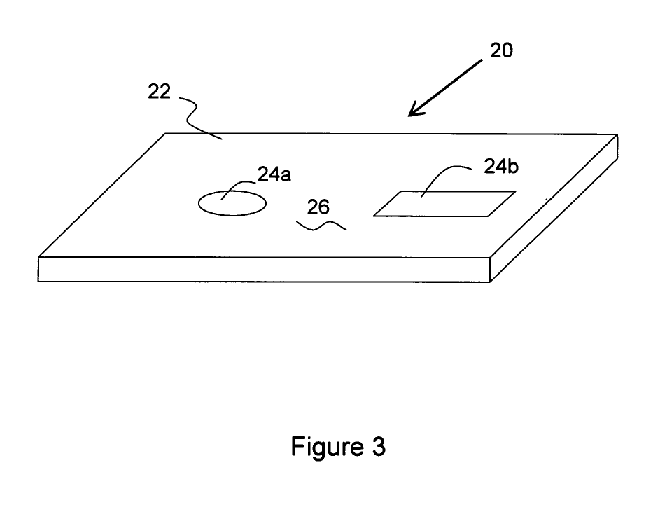

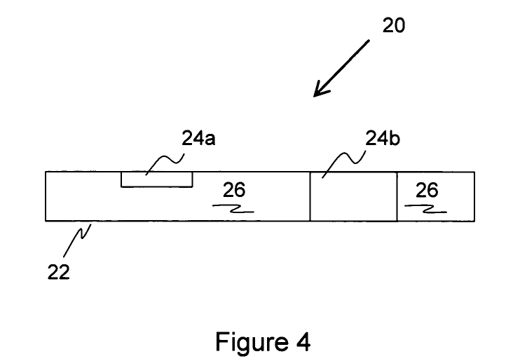

FIG. 3 illustrates another embodiment of a selectively reinforced carbon foam body 20. The selectively reinforced carbon foam body 20 includes a carbon foam body 22 having at least two reinforcement regions 24a and 24b. The reinforcement regions 24a and 24b are portions of the carbon foam body that have been reinforced with a reinforcement material. While the embodiment shown in FIG. 3 illustrates a largely circular reinforcement region 24a and a largely rectangular reinforcement region 24b, the reinforcement regions may form any number of desired regular or irregular geometric patterns on the surface of the carbon foam body. The reinforcement regions 24a and 24b will typically extend from the surface of the carbon foam body into the interior of the carbon foam body 22 a distance of at least four times the average pore diameter of the pores of the carbon foam comprising the carbon foam body. As shown in FIG. 4, the reinforcement regions may extend partially into the interior of the carbon foam body as illustrated by reinforcement region 24a, or extend entirely through the thickness of the carbon foam body as illustrated by reinforcement region 24b.

Reinforcement regions extend into the carbon foam body at least four times the average pore diameter of the pores of the carbon foam comprising the carbon foam body. In some embodiments, the reinforcement regions extend partially or entirely through the thickness of the carbon foam body. Further, a selectively reinforced carbon foam body may have multiple reinforcement regions. These regions may all be similar in size and shape, or alternatively, they may have sizes and shapes different from one another. Still further, the reinforcement regions may extend to different depths in the carbon foam body. Each reinforcement region can vary in size, shape, and extent to which it extends into the carbon foam body, depending on the desired properties of the resulting selectively reinforced carbon foam body. The positioning and configuration of the reinforcement regions is not particularly limited and may vary widely depending upon the application.

The reinforcement region only makes up a portion of the overall selectively reinforced carbon foam body. In many embodiments, the remaining unreinforced region, or portion, of the carbon foam body is typically uninfiltrated, such that the weight of a selectively reinforced carbon foam body is less than that of its fully infiltrated counterpart.

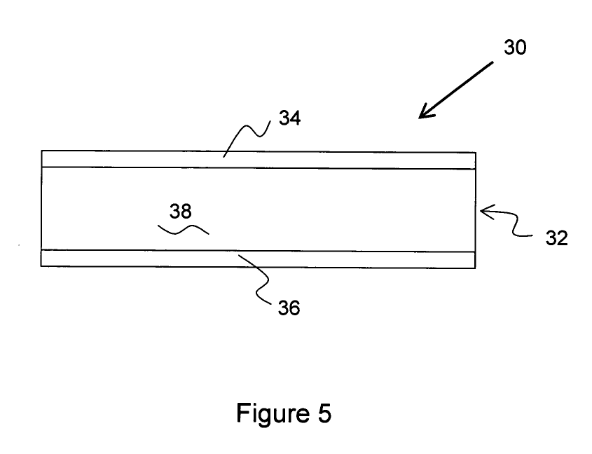

With reference now to FIG. 5, another embodiment of a reinforced carbon foam body 30 is illustrated. The reinforced carbon foam body has a carbon foam body 32 and at least one reinforcement region 34 that substantially matches and includes an exterior surface of the carbon foam body. The reinforcement region 34 extends from the exterior surface into the carbon foam body a distance of at least four times the average pore diameter of the pores making up the carbon foam body. The reinforced carbon foam body has an unreinforced region 38, which, in some embodiments, is uninfiltrated carbon foam. Optionally, additional surfaces of the carbon foam may be provided with a reinforcement region. As shown in FIG. 5, a second reinforcement region 36 may be provided. The second reinforcement region extends from another exterior surface into the carbon foam body a distance of at least four times the average pore diameter of the pores of the carbon foam comprising the carbon foam body.

Carbon foams useful for forming the carbon foam body may be prepared by a variety of methods known in the art. For example, carbon foams have been made from particulate coal, coal extracts, petroleum extracts, coal pitches, coal tar pitches, petroleum pitches, mesophase pitches, mesophase materials, or resinous or polymer foams. The carbon foam may be in the form of a green carbon foam, a carbonized carbon foam, or a graphitized carbon foam.

In certain embodiments the carbon foam forming the carbon foam body has a density ranging from about 0.05 to about 1.0 g/cc, a compressive strength ranging from about 150 p.s.i. to about 10,000 p.s.i., or greater. In some embodiments the carbon foam may have a compressive strength ranging from about 2,000 p.s.i. to about 6,000 p.s.i.

In some embodiments, the carbon foam used to form the carbon foam body may have relatively uniform pore sizes. The size of the pores may vary, but may have values ranging from about 50 μm to about 2 mm. In some embodiments, when carbonized carbon foam is used as the carbon foam body, the carbonized carbon foam has a thermal conductivity below about 1 W/mK.

The reinforcement region is a predetermined region of the carbon foam that comprises a reinforcement material. The reinforcement material should not chemically react with the carbon foam in such way as to significantly degrade the physical properties of the carbon foam. The reinforcement material may be infiltrated within the pores of the carbon foam to a depth of at least four times the average pore diameter of pores of the carbon foam comprising the carbon foam body. The reinforcement material may comprise polymeric materials, for example, thermosetting or thermoplastic polymers. Polymeric materials useful in the reinforcement material may include, but are not limited to, polyurethane, semi-rigid polyurethane, polyethylene, polypropylene, polyester, silicone-based polymers, nylon, latex, rubber, acrylics, polycarbonates, resorcinol resins, furfural resins, isocyanates, epoxies, phenolics, cyanate esters, and other similar materials. Reinforcement materials may also include petroleum pitches, coal-tar pitches, mesophase pitches, tars, mesophase materials, and the like. Further, the reinforcement materials may be either carbonized or uncarbonized. The reinforcement material used for the reinforcement region may be comprised of a single reinforcement material or may include a combination or mixture of two or more reinforcement materials. Where more than one reinforcement region is provided, the reinforcement regions may utilize the same or different reinforcement material.

For purposes of infiltrating the carbon foam body with the desired reinforcement material, a selected area of the carbon foam that will form the reinforcement region is permeated with the appropriate precursors for the selected reinforcement material such that the selected area of the carbon foam is filled with the appropriate precursors. The precursors are then cured, cooled, carbonized, polymerized, cross-linked, or otherwise solidified to provide the appropriate reinforcement material within the pores of the carbon foam, thus providing the reinforcement region.

To adjust properties of the reinforcement materials, the reinforcement materials may further comprise one or more particulate additives such as chopped carbon fibers, nanoparticles, graphite particles, ceramic particles, metallic particles, carbon particles, and other similar additives. The particulate additives should be sized such that they may be permeated into the pores of the carbon foam along with the precursor(s) of the reinforcment material. Further, the particulate additives should not significantly degrade the physical properties of the reinforcement material or carbon foam. Such additives may be mixed with the precursor(s) of the reinforcement material prior to permeating the precursor(s) into the pores of the carbon foam.

A method for producing a selectively reinforced carbon foam body may include determining the desired size, shape and geometry of the carbon foam body. Then the areas of the carbon body in which reinforcement is desired are determined based on the application of the carbon foam body. The size, shape and configuration of the reinforcement region are determined. In one embodiment, a mask may be constructed that will cover the surface of the carbon foam except for an open area that will correspond to the surface shape of the reinforcement region. The mask is applied to the surface of the carbon foam such that the open area of the mask is positioned over the desired reinforcement region of the carbon foam body.

With the mask in place, the precursor to the selected reinforcement material may be coated over the open area of the mask such that the precursor permeates into the pores of the carbon foam body. This step may be repeated as necessary to provide a penetration depth of least four times the average pore diameter of pores of the carbon foam comprising the carbon foam body. The distance the reinforcement material is infiltrated into the carbon foam body may be controlled by controlling the viscosity of the precursor in combination with the pore sizes of the carbon foam. Permeation of the precursor into the carbon foam may be assisted by the use of standard vacuum or pressure techniques.

Where infiltration completely through the body of the carbon foam is desired, it may be useful to employ vacuum techniques to draw the precursor through that region of the carbon foam. This may be accomplished by providing a corresponding mask for the opposing surface of the carbon foam body, sealing the edges of the carbon foam body, and applying a vacuum to draw the precursor through the carbon foam in the reinforcement region. Alternatively positive pressure may be used to force the reinforcement material precursor to the desired depth into the carbon foam body.

The mask may be made of any suitable material, so long as it is able to be removed from the carbon foam body after the precursor(s) to the reinforcement material has been applied, and so long as it does do not significantly degrade or otherwise react with the carbon foam. Suitable masks materials, may include, but are not limited to, plastic sheets, wood sheets, metal sheets, and other similar material.

The use of a mask is optional, that is, reinforcement regions may be created within the carbon foam body without the use of a mask. Standard vacuum and pressure techniques may be used to assist with the permeation of the precursor into the carbon foam body for the resulting reinforcement region.

After the carbon foam body has been permeated with the appropriate precursor for the desired reinforcement material, the precursor is cured, cooled, polymerized, carbonized, cross-linked, or otherwise solidified to form the reinforcement material. Depending on the precursors, heat may be necessary to form the reinforcement material.

Having described several embodiments in detail, the invention is broadly applicable and only limited by the scope of the appended claims.

What is claimed is:

1. A reinforced carbon foam body, comprising:
a carbon foam body comprising carbon foam and having an exterior surface, wherein the carbon foam has an average pore diameter;
at least one reinforcement region within the exterior surface of the carbon foam body and extending from the exterior surface into the carbon foam body a distance of at least four times the average pore diameter; and
an unreinforced region within the carbon foam body.

2. The reinforced carbon foam body of claim 1, further comprising at least two reinforcement regions within the carbon foam body.

3. The reinforced carbon foam body of claim 1, wherein the reinforcement region comprises a reinforcement material infiltrated into a portion of the carbon foam body.

4. The reinforced carbon foam body of claim 3, wherein the reinforcement material extends from one surface of the carbon foam body, through the carbon foam body to another surface of the carbon foam body.

5. The reinforced carbon foam body of claim 3, wherein the reinforcement material comprises a polymeric material selected from the group consisting of polyurethane, semi-rigid polyurethane, polyethylene, polypropylene, polyester, silicone-based polymers, nylon, latex, rubber, acrylics, polycarbonates, resorcinol resins, furfural resins, isocyanates, epoxies, phenolics, and cyanate esters.

6. The reinforced carbon foam of claim 1, wherein the reinforcement material may comprise a material selected from the group consisting of petroleum pitches, coal-tar pitches, mesophase pitches, tars, and mesophase materials.

7. The reinforced carbon foam body of claim 1, wherein the carbon foam has a density ranging from about 0.05 to about 1.0 g/cc and a compressive strength ranging from about 150 p.s.i. to about 10,000 p.s.i.

8. The reinforced carbon foam body of claim 1, wherein the carbon foam has a compressive strength ranging from about 2,000 p.s.i. to about 6,000 p.s.i.

9. The reinforced carbon foam body of claim 1, wherein the carbon foam is green carbon foam.

10. The reinforced carbon foam body of claim 1, wherein the carbon foam is carbonized carbon foam.

11. The reinforced carbon foam body of claim 1, wherein the carbon foam is graphitized carbon foam.

12. The reinforced carbon foam body of claim 1, further comprising at least two reinforcement regions having shapes different from one another.

13. The reinforced carbon foam body of claim 1, wherein the at least one reinforcement region within the exterior surface of the carbon foam body extends from the exterior surface into the carbon foam body a distance ranging from about four to about ten times the average pore diameter.

14. A reinforced carbon foam body, comprising:
a carbon foam body comprising carbon foam and having an exterior surface, wherein the carbon foam has an average pore diameter;
at least one reinforcement region substantially matches and includes the exterior surface of the carbon foam body and extending from the exterior surface into the carbon foam body a distance of at least four times the average pore diameter; and
an unreinforced region within the carbon foam body.

15. The reinforced carbon foam body of claim 14, wherein the reinforcement region comprises a reinforcement material infiltrated into a portion of the carbon foam body.

16. The reinforced carbon foam body of claim 15, wherein the reinforcement material is a polymeric material selected from the group consisting of polyurethane, semi-rigid polyurethane, polyethylene, polypropylene, polyester, silicone-based polymers, nylon, latex, rubber, acrylics, polycarbonates, resorcinol resins, furfural resins, isocyanates, epoxies, phenolics, and cyanate esters.

17. The reinforced carbon foam of claim 13, wherein the reinforcement material may comprise a material selected from the group consisting of petroleum pitches, coal-tar pitches, mesophase pitches, tars, and mesophase materials.

18. The reinforced carbon foam body of claim 14, wherein the carbon foam has a density ranging from about 0.05 to about 1.0 g/cc and a compressive strength ranging from about 150 p.s.i. to about 10,000 p.s.i.

19. The reinforced carbon foam body of claim 14, wherein the carbon foam has a compressive strength ranging from about 2,000 p.s.i. to about 6,000 p.s.i.

20. The reinforced carbon foam body of claim 14, wherein the carbon foam is green carbon foam.

21. The reinforced carbon foam body of claim 14, wherein the carbon foam is carbonized carbon foam.

22. The reinforced carbon foam body of claim 14, wherein the carbon foam is graphitized carbon foam.

23. The reinforced carbon foam body of claim 14, wherein the carbon foam body comprises a second exterior surface and wherein a second reinforcement region substantially matches and includes the second exterior surface of the carbon foam body and extends from the second exterior surface into the carbon foam body a distance of at least four times the average pore diameter.

24. The reinforced carbon foam body of claim 23, wherein the reinforcement region and the second reinforcement region comprise a reinforcement material infiltrated into the pores of the carbon foam body, and wherein the reinforcement material is selected from the group consisting of polyurethane, semi-rigid polyurethane, polyethylene, polypropylene, polyester, silicone-based polymers, nylon, latex, rubber, acrylics, polycarbonates, resorcinol resins, furfural resins, isocyanates, epoxies, phenolics, and cyanate esters.

25. The reinforced carbon foam body of claim 24, wherein the reinforcement material for the reinforcement region is different from the reinforcement material for the second reinforcement region.

26. The reinforced carbon foam body of claim 23, wherein the carbon foam has a density ranging from about 0.05 to about 1.0 g/cc and a compressive strength ranging from about 150 p.s.i. to about 10,000 p.s.i.

27. The reinforced carbon foam body of claim 23, wherein wherein the carbon foam has a compressive strength ranging from about 2,000 p.s.i. to about 6,000 p.s.i.

28. The reinforced carbon foam body of claim 23, wherein the carbon foam is green carbon foam.

29. The reinforced carbon foam body of claim 23, wherein the carbon foam is carbonized carbon foam.

30. The reinforced carbon foam body of claim 23, wherein the carbon foam is graphitized carbon foam.

31. The reinforced carbon foam body of claim 3, wherein the reinforcement material has been carbonized.

32. The reinforced carbon foam body of claim 15, wherein the reinforcement material has been carbonized.
